(19) United States
(12) Patent Application Publication
(10) Pub. No.: US 2026/0136368 A1
(43) Pub. Date: May 14, 2026

(54) SYSTEM INFORMATION SCHEDULING IN OVERLAPPING WINDOWS

(71) Applicant: QUALCOMM Incorporated, San Diego, CA (US)

(72) Inventors: Kuhn-Chang LIN, Chiayi City (TW); Jen-Chun CHANG, New Taipei City (TW); Wen-Hsin HSIA, New Taipei City (TW); Sheng-Chih WANG, New Taipei City (TW); Chun-Hsiang CHIU, Yonghe Dist. (TW); Chenghsin LIN, New Taipei City (TW); Kai-Chun CHENG, Taipei City (TW); Chung Wei LIN, Taipei City (TW); Yu-Chieh HUANG, Taipei City (TW)

(21) Appl. No.: 18/942,344

(22) Filed: Nov. 8, 2024

(51) Int. Cl. H04W 72/23; H04L 5/00

(52) U.S. Cl. CPC H04W 72/23; H04L 5/0048

(57) ABSTRACT

This disclosure provides systems, methods and apparatuses for communicating system information within overlapping windows. A network entity outputs a first physical downlink control channel (PDCCH) and a second PDCCH via overlapping windows. The network entity outputs a first system information message via resources indicated by the first PDCCH. The network entity outputs a second system information message on via resources indicated by the second PDCCH. A user equipment (UE) can obtain the first PDCCH and the second PDCCH via the overlapping windows. The UE can then obtain the first system information message via resources indicated by the first PDCCH and obtain the second system information message on via resources indicated by the second PDCCH.

### TECHNICAL FIELD

The present disclosure relates to wireless communications including system information scheduling in overlapping windows.

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (such as with Internet of Things (IOT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard.

### SUMMARY

The systems, methods and devices of this disclosure each have several innovative aspects, no single one of which is solely responsible for the desirable attributes disclosed herein.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is a diagram illustrating an example of a wireless communications system including an access network.

FIG. 2A is a diagram illustrating an example of a first frame.

FIG. 2B is a diagram illustrating an example of DL channels within a subframe.

FIG. 2C is a diagram illustrating an example of a second frame.

FIG. 2D is a diagram illustrating an example of a subframe.

FIG. 3 is a diagram illustrating an example of a base station (BS) and user equipment (UE) in an access network.

FIG. 4 is a diagram illustrating an example disaggregated base station architecture.

FIG. 5 is a diagram of system information scheduling in non-overlapping system information (SI) windows.

FIG. 6 is a diagram of system information scheduling in non-overlapping SI windows with offset periods.

FIG. 7 is a diagram of an example of system information scheduling with overlapping SI windows.

FIG. 8 is a diagram of an example of transmission of control information for two SI messages within a common control resource set (CORESET).

FIG. 9 is a diagram of an example of transmission of control information for two SI messages within different CORESETs.

FIG. 10 is a conceptual data flow diagram illustrating the data flow between different means/components in an example network entity including a SIB Tx component.

FIG. 11 is a conceptual data flow diagram illustrating the data flow between different means/components in an example UE including a SIB Rx component.

FIG. 12 is a flowchart of an example method for a wireless node such as a UE to obtain system information via overlapping windows.

FIG. 13 is a flowchart of an example method for a wireless node such as a network entity to deliver system information within overlapping windows.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. Some of the examples in this disclosure are based on wireless and wired local area network (LAN) communication according to the Institute of Electrical and Electronics Engineers (IEEE) 802.11 wireless standards, the IEEE 802.3 Ethernet standards, and the IEEE 1901 Powerline communication (PLC) standards. However, the described implementations may be implemented in any device, system or network that is capable of transmitting and receiving RF signals according to any of the wireless communication standards, including any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, 6G or further implementations thereof, technology.

In wireless communications, a network entity may generate system information that is then broadcast by a base station to user equipment (UE) in a coverage area. The system information may be organized into system information blocks (SIBs). The base station may transmit a first SIB (SIB1) on dedicated resources. SIB1 includes scheduling information for the other SIBs. The base station may transmit the other SIBs on a physical downlink shared channel (PDSCH) as SI messages within time domain windows referred to as SI-windows. Each SI message is associated with an SI-window, and the SI-windows of different SI messages do not overlap. That is, within one SI-window only the corresponding SI message is transmitted. An SI message may be repeated with the same content a number of times within the SI-window.

As various features are added to wireless networks, the amount of system information that can be transmitted also grows. The increase in system information creates a scheduling problem because most of the SI-windows are used by current 5G system information blocks. Although some additional SIBs may be transmitted with a relatively long periodicity, the current limits on SI-windows limits the ability of the network to expand the amount of system information that is broadcast.

In an aspect, the present disclosure provides techniques to transmit system information using overlapping SI-windows. By relaxing the requirements of SI-windows, multiple SI messages may be scheduled on the PDSCH within one SI-window. For example, the SI-window may include multiple physical downlink control channel (PDCCH) candidates that schedule transmission of SIBs on the PDSCH. A UE may distinguish the different PDCCH candidates based on different system information radio network temporary identifiers (SI-RNTIs), based on different control resource sets (CORESETs), and/or based on different control information indications.

In an aspect, the techniques disclosed herein are backwards compatible such that a legacy device may receive a first SI message in a SI-window, but a UE according to the present disclosure can receive the first SI message in the SI-windows and/or a second SI message in the SI-window. Accordingly, the system information available to a UE according to the present disclosure can be increased without interfering with performance of legacy devices.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. The processor may include an interface or be coupled to an interface that can obtain or output signals. The processor may obtain signals via the interface and output signals via the interface. In some implementations, the interface may be a printed circuit board (PCB) transmission line. In some other implementations, the interface may include a wireless transmitter, a wireless transceiver, or a combination thereof. For example, the interface may include a radio frequency (RF) transceiver which can be implemented to receive or transmit signals, or both. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example implementations, the functions described may be implemented in hardware, software, or any combination thereof. If implemented in software, the functions may be stored on or encoded as one or more instructions or code on a computer-readable medium. Computer-readable media includes computer storage media, which may be referred to as non-transitory computer-readable media. Non-transitory computer-readable media may exclude transitory signals. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

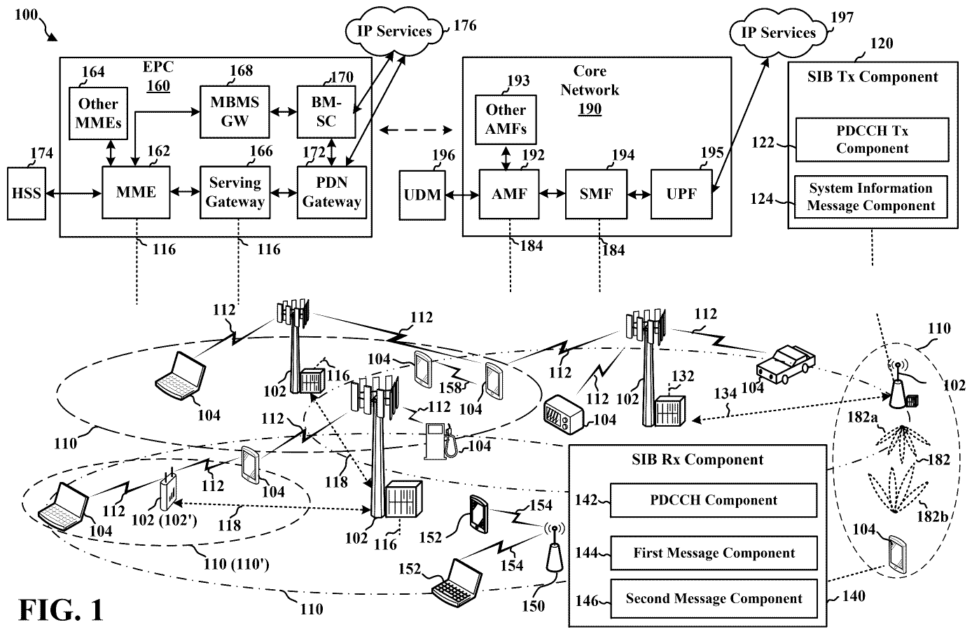

FIG. 1 is a diagram illustrating an example of a wireless communications system and an access network 100. The wireless communications system (also referred to as a wireless wide area network (WWAN)) includes wireless nodes such as base stations 102 and UEs 104, an Evolved Packet Core (EPC) 160, and another core network 190 (such as a 5G Core (5GC)). The base stations 102 may include macrocells (high power cellular base station) or small cells (low power cellular base station). The macrocells include base stations. The small cells include femtocells, picocells, and microcells. The small cells include femtocells, picocells, and microcells. The base stations 102 can be configured in a Disaggregated RAN (D-RAN) or Open RAN (O-RAN) architecture, where functionality is split between multiple units such as one or more central units (CUs) 188, one or more distributed units (DUs) 186, or a radio unit (RU) 180. Such architectures may be configured to utilize a protocol stack that is logically split between one or more units (such as one or more CUs and one or more DUs). In some aspects, the CUS 188 may be implemented within an edge RAN node, and in some aspects, one or more DUs 186 may be co-located with a CU 188, or may be geographically distributed throughout one or multiple RAN nodes. The DUs 186 may be implemented to communicate with one or more RUs 180.

In some implementations, one or more wireless nodes such as the UEs 104 include a SIB Rx component 140 configured to receive multiple system information messages via overlapping system information windows. The SIB Rx component 140 includes a PDCCH component, a first message component 144, and a second message component 146. The PDCCH component 142 is configured to output a first PDCCH 1030 and a second PDCCH 1032 for transmission via overlapping windows. The first message component 144 is configured to output for transmission a first system information message via resources indicated by the first PDCCH. The second message component 146 is configured to output for transmission a second system information message via resources indicated by the second PDCCH.

In some implementations, one or more of wireless nodes such as the network entities including a base station 102 may include a SIB Tx component 120. In particular, the SIB Tx component 120 is configured to transmit multiple system information messages within overlapping windows. The SIB Tx component 120 includes a PDCCH Tx component 122 configured to output a first PDCCH and a second PDCCH for transmission via overlapping windows. The SIB Tx component 120 includes a system information message component 124 configured to output for transmission a first system information message via resources indicated by the first PDCCH and output for transmission a second system information message via resources indicated by the second PDCCH.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 116 (such as S1 interface), which may be wired or wireless. The base stations 102 configured for 5G NR (collectively referred to as Next Generation RAN (NG-RAN)) may interface with core network 190 through second backhaul links 184, which may be wired or wireless. In addition to other functions, the base stations 102 may perform one or more of the following functions: transfer of user data, radio channel ciphering and deciphering, integrity protection, header compression, mobility control functions (such as handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (such as through the EPC 160 or core network 190) with each other over third backhaul links 118 (such as X2 interface). The third backhaul links 118 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network also may include Home Evolved Node Bs (eNBs) (HeNBs), which may provide service to a restricted group known as a closed subscriber group (CSG). The communication links 112 between the base stations 102 and the UEs 104 may include UL (also referred to as reverse link) transmissions from a UE 104 to a base station 102 or DL (also referred to as forward link) transmissions from a base station 102 to a UE 104. The communication links 112 may use multiple-input and multiple-output (MIMO) antenna technology, including spatial multiplexing, beamforming, or transmit diversity. The communication links may be through one or more carriers. The base stations 102/UEs 104 may use spectrum up to Y MHz (such as 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (such as more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to or increase capacity of the access network.

A base station 102, whether a small cell 102′ or a large cell (such as macro base station), may include an eNB, gNodeB (gNB), or other type of base station. Some base stations, such as gNB may operate in one or more frequency bands within the electromagnetic spectrum.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band. Communications using the mmW radio frequency band have extremely high path loss and a short range. The mmW base station may utilize beamforming 182 with the UE 104 to compensate for the path loss and short range. For example, the base station 102 may use beamforming 182 to transmit beams 182a and the UE 104 may utilize beamforming 182 to transmit beams 182b.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, or other IP services.

The base station may include or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (such as a MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (such as a parking meter, gas pump, toaster, vehicles, heart monitor, etc.). The UE 104 also may be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the following description may be focused on 6G, the concepts described herein may be applicable to other similar areas, such as 5G NR, LTE, LTE-A, CDMA, GSM, and other wireless technologies including future wireless technologies.

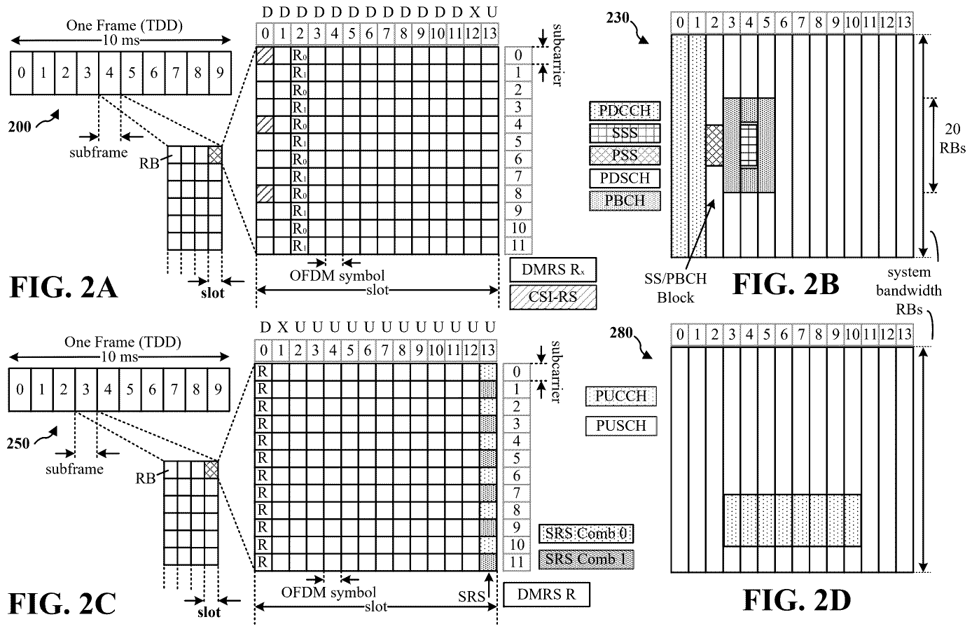

FIG. 2A is a diagram 200 illustrating an example of a first frame. FIG. 2B is a diagram 230 illustrating an example of DL channels within a subframe. FIG. 2C is a diagram 250 illustrating an example of a second frame. FIG. 2D is a diagram 280 illustrating an example of a subframe. The 5G NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. A subset of the total cell bandwidth of a cell is referred to as a Bandwidth Part (BWP) and bandwidth adaptation is achieved by configuring the UE with BWP(s) and telling the UE which of the configured BWPs is currently the active one. In an aspect, a narrow bandwidth part (NBWP) refers to a BWP having a bandwidth less than or equal to a maximum configurable bandwidth of a BWP. The bandwidth of the NBWP is less than the carrier system bandwidth.

In the examples provided by FIGS. 2A, 2C, the 5G NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure or different channels. A frame (10 milliseconds (ms)) may be divided into 10 equally sized subframes (1 ms). Each subframe may include one or more time slots. Subframes also may include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 20^{μ}*15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 microseconds (μs).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DMRS) (indicated as Rx for one particular configuration, where 100x is the port number, but other DM-RS configurations are possible) and channel state information reference signals (CSI-RS) for channel estimation at the UE. The RS also may include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a L1 identity. A secondary synchronization signal (SSS) may be within symbol 4 of particular subframes of a frame. The SSS is used by a UE to determine a L1 cell identity group number and radio frame timing. Based on the L1 identity and the L1 cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), or UCI.

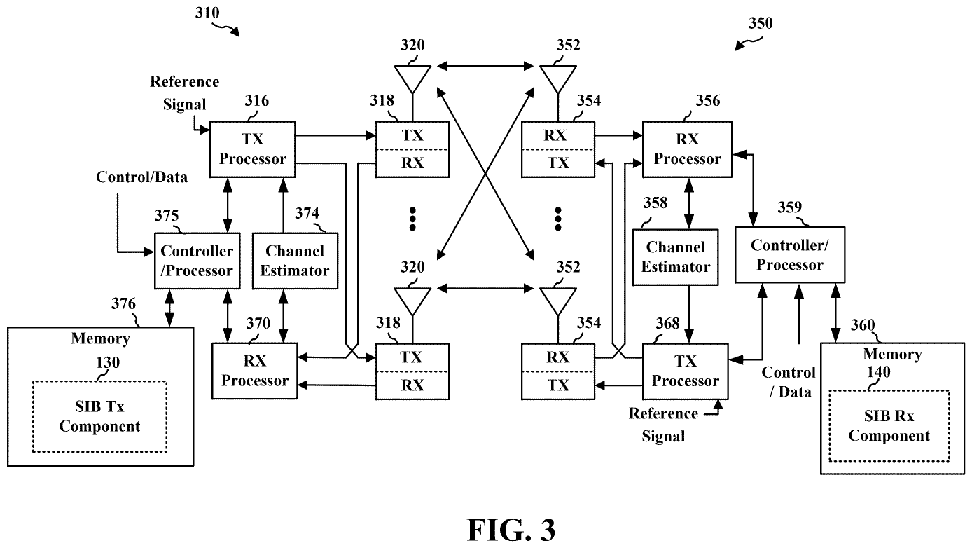

FIG. 3 is a diagram of an example of a base station 310 and a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (such as MIB, SIBs), RRC connection control (such as RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (such as binary phase-shift keying (BPSK), quadrature phase-shift keying (QPSK), M-phase-shift keying (M-PSK), M-quadrature amplitude modulation (M-QAM)). The coded and modulated symbols may be split into parallel streams. Each stream may be mapped to an OFDM subcarrier, multiplexed with a reference signal (such as a pilot) in the time or frequency domain, and combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal or channel condition feedback transmitted by the UE 350. Each spatial stream may be provided to a different antenna 320 via a separate transmitter 318TX. Each transmitter 318TX may modulate an RF carrier with a respective spatial stream for transmission. In a split architecture, the transmitters/receivers 318 may be located in an RU 180, and the Tx processor 316, channel estimator 374, controller/processor 375, and Rx processor 370 may be located in a DU 186.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are decoded and deinterleaved to recover the data and control signals that were originally transmitted by the base station 310 on the physical channel. The data and control signals are provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK or NACK protocol to support HARQ operations.

Similar to the functionality described in connection with the DL transmission by the base station 310, the controller/processor 359 provides RRC layer functionality associated with system information (such as MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK or NACK protocol to support HARQ operations.

At least one of the TX processor 368, the RX processor 356, and the controller/processor 359 may be configured to perform aspects in connection with the SIB Rx component 140 of FIG. 1. For example, the memory 360 may include executable instructions defining the SIB Rx component 140. The TX processor 368, the RX processor 356, and/or the controller/processor 359 may be configured to execute the SIB Rx component 140.

At least one of the TX processor 316, the RX processor 370, and the controller/processor 375 may be configured to perform aspects in connection with the SIB delivery component 130 of FIG. 1. For example, the memory 376 may include executable instructions defining the SIB Tx component 120. The TX processor 316, the RX processor 370, and/or the controller/processor 375 may be configured to execute the SIB Tx component 120.

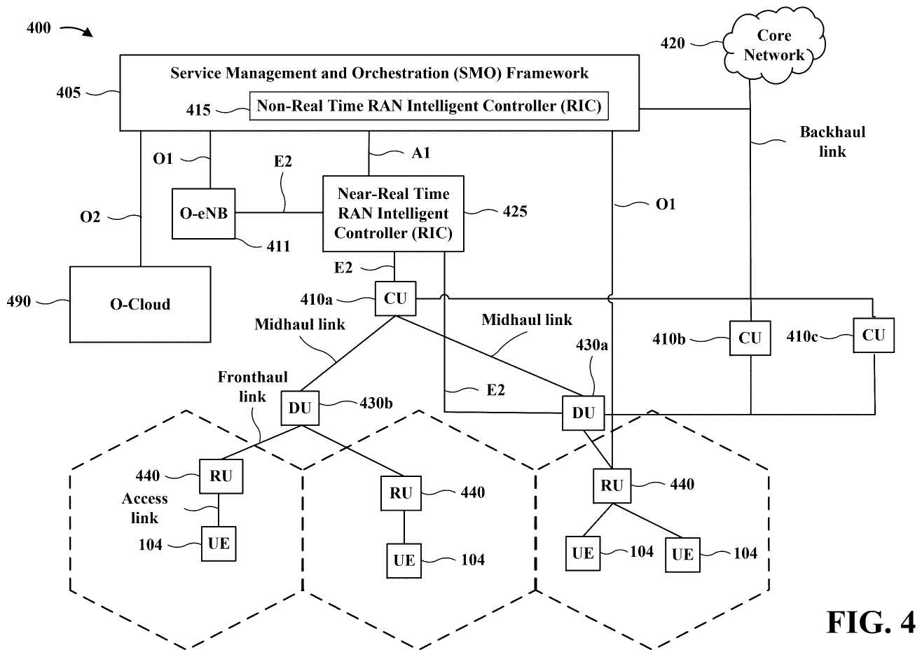

FIG. 4 is a diagram illustrating an example disaggregated base station 400 architecture. The disaggregated base station 400 architecture may include one or more central units (CUs) 410 that can communicate directly with a core network 420 via a backhaul link, or indirectly with the core network 420 through one or more disaggregated base station units (such as a Near-Real Time (Near-RT) RAN Intelligent Controller (RIC) 425 via an E2 link, or a Non-Real Time (Non-RT) RIC 415 associated with a Service Management and Orchestration (SMO) Framework 405, or both). A CU 410 may communicate with one or more distributed units (DUs) 430 via respective midhaul links, such as an F1 interface. The DUs 430 may communicate with one or more radio units (RUs) 440 via respective fronthaul links. The RUs 440 may communicate with respective UEs 104 via one or more radio frequency (RF) access links. In some implementations, the UE 104 may be simultaneously served by multiple RUs 440.

Each of the units, i.e., the CUS 410, the DUs 430, the RUs 440, as well as the Near-RT RICs 425, the Non-RT RICs 415 and the SMO Framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., Central Unit-User Plane (CU-UP)), control plane functionality (i.e., Central Unit-Control Plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a vRAN architecture.

The SMO Framework 405 may be configured to support RAN deployment and provisioning of non-virtualized and virtualized network elements. For non-virtualized network elements, the SMO Framework 405 may be configured to support the deployment of dedicated physical resources for RAN coverage requirements which may be managed via an operations and maintenance interface (such as an O1 interface). For virtualized network elements, the SMO Framework 405 may be configured to interact with a cloud computing platform (such as an open cloud (O-Cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and Near-RT RICs 425. In some implementations, the SMO Framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO Framework 405 also may include a Non-RT RIC 415 configured to support functionality of the SMO Framework 405.

The Non-RT RIC 415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 425. The Non-RT RIC 415 may be coupled to or communicate with (such as via an A1 interface) the Near-RT RIC 425. The Near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the Near-RT RIC 425.

In some implementations, to generate AI/ML models to be deployed in the Near-RT RIC 425, the Non-RT RIC 415 may receive parameters or external enrichment information from external servers. Such information may be utilized by the Near-RT RIC 425 and may be received at the SMO Framework 405 or the Non-RT RIC 415 from non-network data sources or from network functions. In some examples, the Non-RT RIC 415 or the Near-RT RIC 425 may be configured to tune RAN behavior or performance. For example, the Non-RT RIC 415 may monitor long-term trends and patterns for performance and employ AI/ML models to perform corrective actions through the SMO Framework 405 (such as reconfiguration via O1) or via creation of RAN management policies (such as A1 policies).

In an aspect, a 6G split architecture may include a multi-CU shared DU. That is, multiple CUs 410 (e.g., CUs 410a, 410b, 410c) may be allowed to control a DU 430a. In order to prevent conflicts, one CU 410 (e.g., CU 410a) may be designated as a primary CU for the DU. For instance, the DU 430a may prioritize the CUS 410 such that in the event of a conflict, the higher priority CU (e.g., the primary CU 410a) controls. In some implementations, the radio resource control (RRC) layer may be located in the CU 410. A specific UE 104 may establish an RRC connection with an CU 410. The CU 410 with the RRC connection to a UE may be referred to as the anchor CU of the UE. Accordingly, as used herein with respect to a CU, the terms primary and secondary refer to the priority of the CU for a specific DU, and the term anchor refers to the endpoint of an RRC connection with a UE.

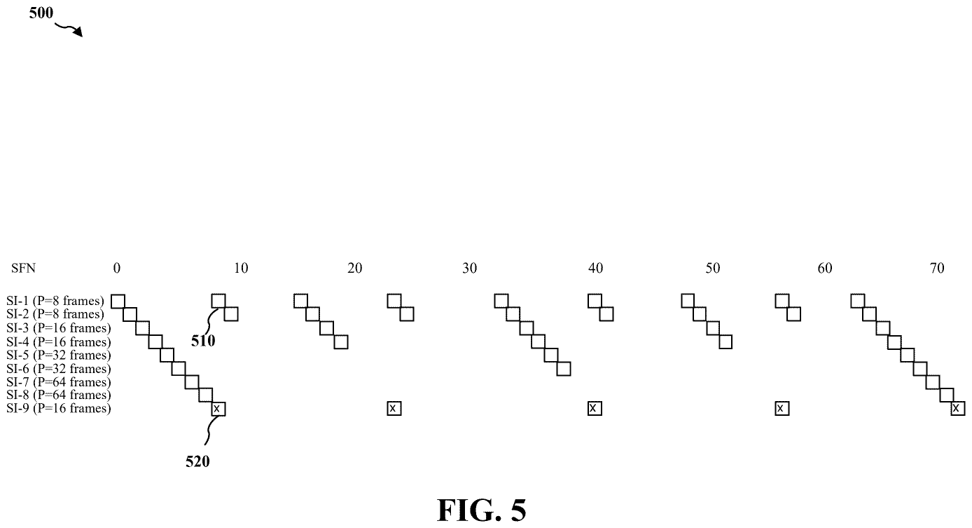

FIG. 5 is a diagram 500 of system information scheduling in non-overlapping SI windows. In the illustrated example, each SI window may be one frame. Two SI messages (SI-1 and SI-2) are transmitted with a periodicity of 8 frames, two SI messages (SI-3 and SI-4) are transmitted with a periodicity of 16 frames, two SI messages (SI-5 and SI-6) are transmitted with a periodicity of 32 frames, and two SI messages (SI-7 and SI-8) are transmitted with a periodicity of 64 frames. If a ninth SI message (SI-9) is to be added, the SI-9 cannot be transmitted in the SI window of system frame number (SFN) 8 because that SI window 520 would overlap with the SI window 510 for SI-1.

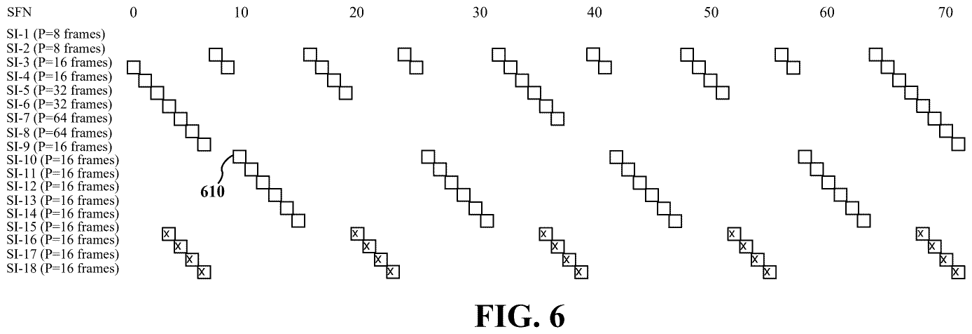

FIG. 6 is a diagram 600 of system information scheduling in non-overlapping SI windows with offset periods. The first eight SI messages (SI-1-SI-8) may be scheduled as in FIG. 5. The ninth SI message (SI-9) may be scheduled in an SI-window 610 in SFN 10. That is, SI-9 has a period that is offset. SI-9 has a periodicity of 16 frames, so the SI-window 610 alternates with the SI window for SI-3 and does not overlap. This technique of scheduling SI-windows with an offset allows scheduling of additional SI messages with longer periodicity. For example, SI messages 9-14 may be scheduled with a 16 frame periodicity. SI-15, however, would again overlap with SI-1. It may be possible to schedule SI-15 with a greater offset and longer periodicity (e.g., in SFN 20 with a 32 frame periodicity), but 18 SI messages is approaching the limit of this scheduling approach.

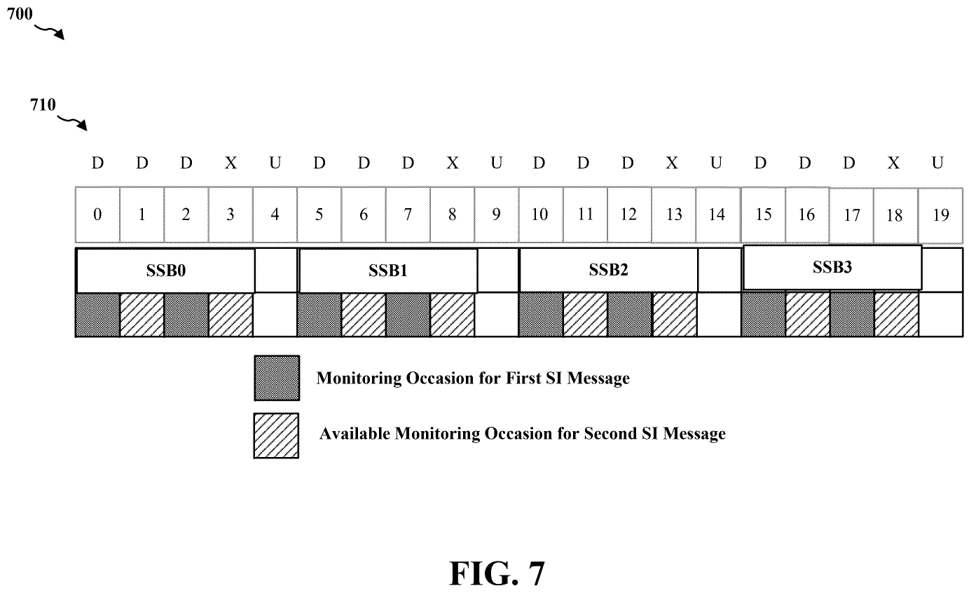

FIG. 7 is a diagram 700 of an example of system information scheduling with overlapping SI windows. In the illustrated example, a frame 710 with a sub-carrier spacing of 30 KHz may include 20 slots. A slot pattern may include three downlink slots followed by a special slot and an uplink slot. This slot pattern would allow transmission in sixteen (16) slots of the frame. Further, assuming an actual number of synchronization signal blocks (SSBs) transmitted is four (4), a PDCCH scheduling an SI message may be transmitted for each SSB, resulting in least four transmissions. The number of transmissions may increase if the SI messages are repeated. Nevertheless, some PDCCH occasions may not be used to carry a DCI for a first SI message. The additional PDCCH occasions may be available for transmission of a DCI for a second SI message that overlaps the SI-window for the first SI message.

In an aspect, the present disclosure provides additional SI message signaling with backwards compatibility by allowing SI message to overlap within an SI-window (e.g., a frame). The PDCCH for the new SI message may be distinguished from the PDCCH for the legacy SI messages based on different SI-RNTI values, based on different CORESETs, or based on different values in a DCI.

The scheduling for the SI message is transmitted as a downlink control information (DCI) on a PDCCH candidate within a CORESET. The UE is configured with a CORESET and attempts to blind decode each PDCCH candidate within the CORESET. Conventionally, the DCI for an SI message has a cyclic redundancy check (CRC) that is scrambled with a system information radio network temporary identifier (SI-RNTI) that has a fixed value (e.g., 0xFFFF) that is defined in a standards document. In an aspect, the DCI for the second SI message that overlaps the SI-window may have a second SI-RNTI. For instance, the second SI-RNTI may have a value defined in a standards document or signaled in a previous system information block (e.g., SIB1). For instance, RNTI values 0xFFF3-0xFFF8 are reserved in the 5G standard and one or more of these values could be allocated to the second SI-RNTI. A legacy UE may not be configured with the second SI-RNTI, so the legacy UE may only successfully blind decode the DCI for the first SI message. A UE according to the present disclosure may alternatively or additionally check the PDCCH candidates using the second SI-RNTI. Decoding complexity is not significantly increased because only the CRC scrambling changes. Accordingly, the UE may decode the DCI for the second SI message.

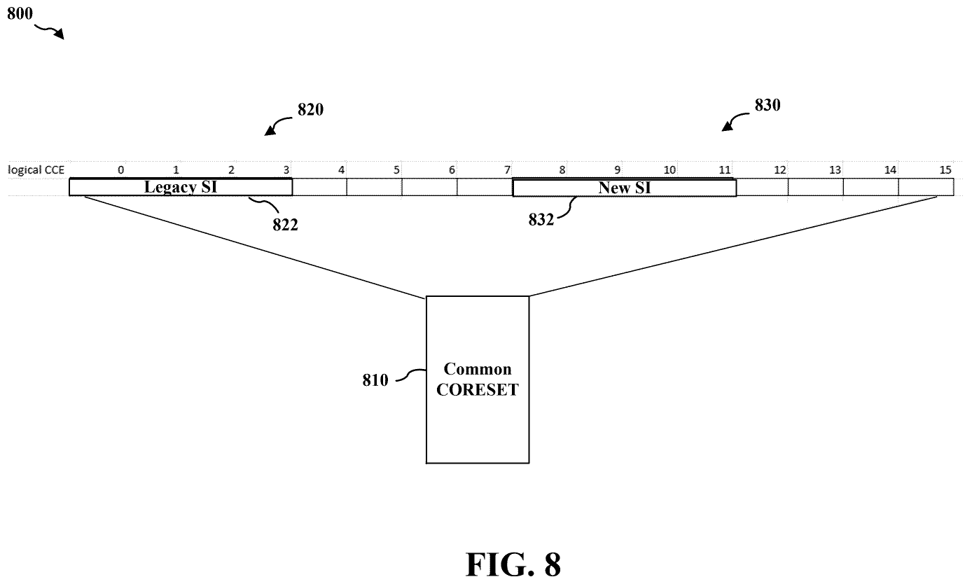

FIG. 8 is a diagram 800 of an example of transmission of DCI for two SI messages within a common CORESET 810. The common CORESET 810 may indicate a number of logical control channel elements (CCEs). For instance, the common CORESET may be a set of resources on which control information may be transmitted. A UE may be configured with one or more search spaces within a CORESET 810 that the UE attempts to blind decode in each frame. For instance, a first search space 820 may include CCE0-CCE 7 and a second search space 830 may include CCE8-CCE15. A PDCCH candidate include a number of CCEs to decode based on an aggregation level. For example, as illustrated, each PDCCH candidate is 4 CCEs for aggregation level 4. A PDCCH candidate 822 (on CCE0-CCE3) may include a DCI for a first SI message (e.g., a legacy SI message). A PDCCH candidate 832 (on CCE8 to CCE11) may include a DCI for a second SI message (e.g., a new SI message). Accordingly, there may be more than one active PDCCH candidate within a CORESET. A UE that is configured with both the first SI-RNTI and the second SI-RNTI may detect a DCI on each active PDCCH candidate. The UE may associate the legacy SI message with the DCI detected using the legacy SI-RNTI and associate the new SI message with the DCI detected using the second SI-RNTI.

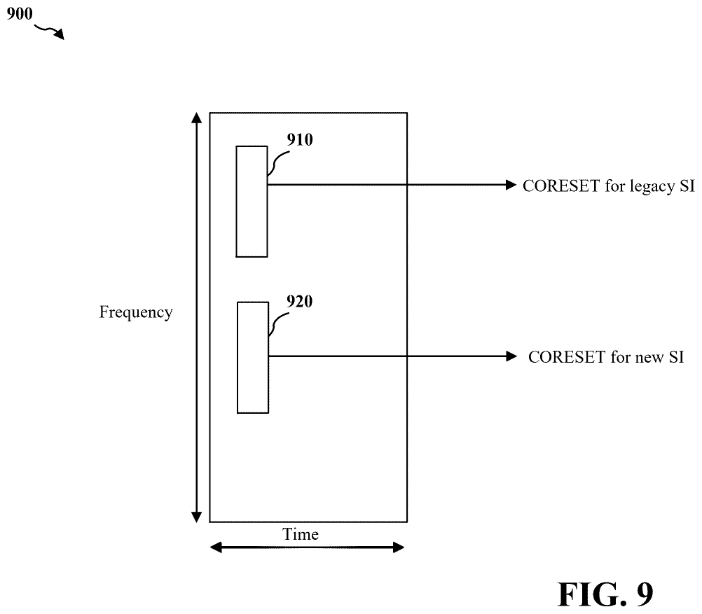

FIG. 9 is a diagram 900 of an example of transmission of DCI for two SI messages within different CORESETs. A first CORESET 910 may be a legacy CORESET for SI messages. For instance, the first CORESET 910 may be a common CORESET defined in a PDCCHConfigCommon parameter and a pdcch-ConfigSIB1 parameter carried in a master information block (MIB). The second CORESET 920 may be a non-overlapping CORESET. The second CORESET 920 may include a PDCCH candidate carrying DCI for the second SI message. In an aspect, the second CORESET may be defined in another SIB or configured via RRC signaling (e.g., based on a capability of the UE). A legacy UE may blind decode only the first CORESET 910, which may only carry legacy SI messages. A UE according the present disclosure may additionally or alternatively blind decode the second CORESET 920. With separate CORESETs the same SI-RNTI may be used for both active PDCCH candidates. The UE may associate the DCI with the correct SI message based on the CORESET on which the DCI was detected. In some implementations, the second SI-RNTI may be used.

In another aspect, a content of the DCI may be used to differentiate the DCI for the legacy SI message from the DCI for the new SI message. For example, a DCI may include a system information indicator field. The system information indicator field may indicate a type of the SI message. For example, the system information indicator field may have a value corresponding to one of: SIB 1, a legacy SI message, or a new SI message. In some implementations, a DCI format may need an additional bit to represent the value for the new SI messages. Accordingly, these implementations may not be backward compatible.

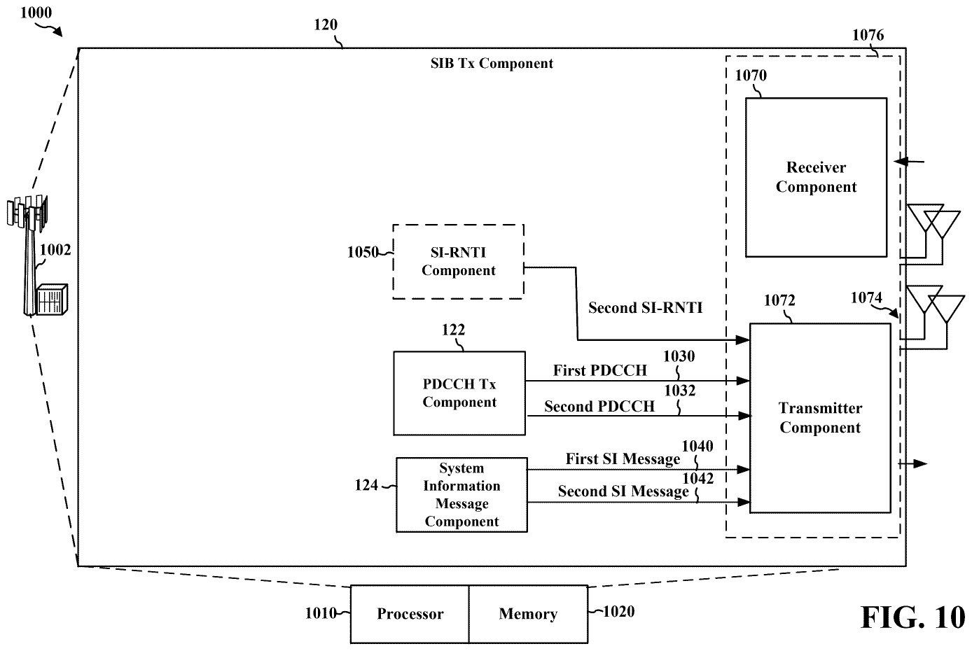

FIG. 10 is a conceptual data flow diagram 1000 illustrating the data flow between different means/components in an example network entity 1002 including a SIB Tx component 120. For example, the network entity 1002 may be an example of a network node such as the base station 102 (FIG. 1) including the SIB Tx component 120. In some implementations, the SIB Tx component 120 may be implemented by the memory 376 and the TX processor 316, the RX processor 370, and/or the controller/processor 375 of FIG. 3. For example, the memory 376 may store executable instructions defining the SIB Tx component 120 and the TX processor 316, the RX processor 370, and/or the controller/processor 375 may execute the instructions. In other implementations, the SIB Tx component 120 may be implemented on computing resources including one or more processors 1010 and one or more memories 1020. For example, the SIB Tx component 120 may be implemented on a virtual DU in a datacenter.

As discussed with respect to FIG. 1, the SIB Tx component 120 may include the PDCCH Tx component and the system information message component 124.

The network entity 1002 may include a receiver component 1070, which may include, for example, a radio frequency (RF) receiver for receiving the signals described herein. The network entity 1002 may include a transmitter component 1072, which may include, for example, an RF transmitter for transmitting the signals described herein. The transmitter component 1072 may output RF signals to one or more antennas 1074. In an aspect, the receiver component 1070 and the transmitter component 1072 may be co-located in a transceiver 1076, which may correspond to the TX/RX 318 in FIG. 3.

The PDCCH Tx component 122 is configured to output a first PDCCH 1030 and a second PDCCH 1032 for transmission in overlapping windows. For example, the PDCCH Tx component 122 may output both the first PDCCH 1030 and the second PDCCH 1032 in a same SI-window such as the frame 710. The PDCCH Tx component 122 may output the first PDCCH 1030 and the second PDCCH 1032 such that a UE may distinguish each PDCCH and associate each PDCCH with a respective SI message.

In some implementations, the PDCCH Tx component 122 may output the first PDCCH 1030 and the second PDCCH 1032 with respective CRCs scrambled with different SI-RNTIs (e.g., a first SI-RNTI and a second SI-RNTI). In some implementations, when the first PDCCH 1030 and the second PDCCH 1032 have CRCs scrambled with different SI-RNTIs, the PDCCH Tx component 122 may output the first PDCCH 1030 and the second PDCCH 1032 for transmission in a same slot on non-overlapping logical CCEs. In some implementations, the PDCCH Tx component 122 may output the first PDCCH 1030 and the second PDCCH 1032 for transmission in different slots within the overlapping windows.

In some implementations, the PDCCH Tx component 122 may output the first PDCCH 1030 for transmission on a first set of CCEs (e.g., PDCCH candidate 822) and output the second PDCCH 1032 for transmission on a second set of CCEs (e.g., PDCCH candidate 832) within a same CORESET 810. In some implementations, the second set of CCEs is a different search space 830 than a search space 820 including the first set of CCEs. The first set of CCEs and the second set of CCEs may have a same or different aggregation level.

In some implementations, the PDCCH Tx component 122 may output the first PDCCH 1030 for transmission on a first CORESET 910 and output the second PDCCH 1032 for transmission on a second CORESET 920.

In some implementations, the PDCCH Tx component 122 may output the first PDCCH 1030 with a first control information and may output the second PDCCH 1032 with a second control information. The content of the first control information may include one or both of a SIB identifier or a SIB version of a first system information message. The content of the second control information may include one or both of a SIB identifier or a SIB version of a second system information message.

The system information message component 124 is configured to output for transmission a first system information message 1040 via resources indicated by the first PDCCH 1030 and output for transmission a second system information message 1042 via resources indicated by the second PDCCH 1032. For example, the system information message component 124 may output the first system information message 1040 and the second system information message 1042 on a physical downlink shared channel.

In some implementations, the SIB Tx component 120 may optionally include a SI-RNTI component 1050 that is configured to output for transmission a first SIB that indicates the second SI-RNTI. In some implementations, the first SIB may be SIB1, which may be transmitted via resources indicated in a MIB. In some implementations, the first SIB may be transmitted in a first SI message 1040. In some implementations, the SI-RNTI component 1050 may output the second SI-RNTI for transmission via an RRC message. In other implementations, the second SI-RNTI may be a predefined value, for example, in a standards document.

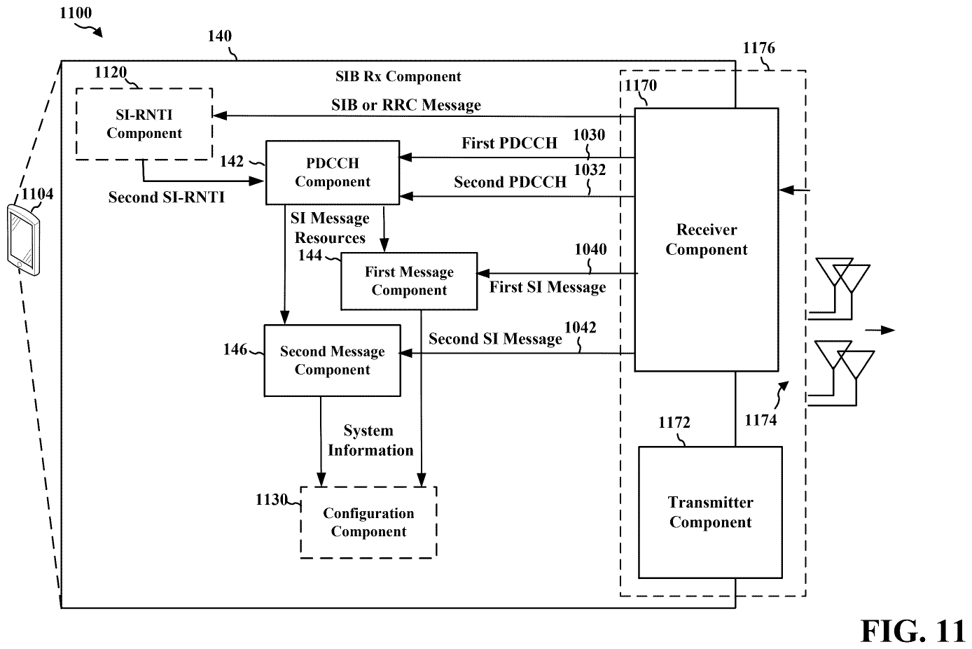

FIG. 11 is a conceptual data flow diagram 1100 illustrating the data flow between different means/components in an example UE 1104 including a SIB Rx component 140. For example, the UE 1104 may be an example of a wireless node such as the UE 104 (FIG. 1) including the SIB Rx component 140. The SIB Rx component 140 may be implemented by the memory 360 and the TX processor 368, the RX processor 356, and/or the controller/processor 368 of FIG. 3. For example, the memory 360 may store executable instructions defining the SIB Rx component 140 and the TX processor 368, the RX processor 356, and/or the controller/processor 359 may execute the instructions.

The UE 1104 may include a receiver component 1170, which may include, for example, a radio frequency (RF) receiver for receiving the signals described herein. The UE 1104 may include a transmitter component 1172, which may include, for example, an RF transmitter for transmitting the signals described herein. The transmitter component 1172 may output RF signals to one or more antennas 1174. In an aspect, the UE 1104 and the transmitter component 1172 may be co-located in a transceiver 1176, which may correspond to the TX/RX 354 in FIG. 3.

As discussed with respect to FIG. 1, the SIB Rx component 140 may include the PDCCH component 142, the first message component 144, and the second message component 146. In some implementations, the SIB Rx component 140 may optionally include an SI-RNTI component 1120 and/or a configuration component 1130.

The receiver component 1170 may receive signals from a network entity such as a base station 102. For example, the receiver component 1170 may receive the first PDCCH 1030, the second PDCCH 1032, the first SI message 1040, and the second SI message 1042. The receiver component 1170 may provide the first PDCCH 1030 and the second PDCCH 1032 to the PDCCH component 142. The receiver component 1170 may provide the first SI message 1040 to the first message component 144. The receiver component 1170 may provide the second SI message 1042 to the second message component 146. In some implementations, the receiver component 1170 may output a SIB or an RRC message to an SI-RNTI component 1120.

In some implementations, the SI-RNTI component 1120 is configured to determine a second SI-RNTI. For instance, the SI-RNTI component 1120 may obtain a SIB or an RRC message that indicates the second SI-RNTI. In some implementations, the second SI-RNTI may be predefined, for example, in a standards document. The SI-RNTI component 1120 may be configured with a predefined value for the second SI-RNTI.

The PDCCH component 142 is configured to obtain a PDCCH and a second PDCCH via overlapping windows. For instance, the receiver component 1170 may provide the PDCCH component 142 with signals received on one or more search spaces within one or more CORESETs corresponding to the overlapping windows. For instance, the overlapping windows may be a frame 710. The first PDCCH 1030 and the second PDCCH 1032 may be considered PDCCH candidates. The PDCCH component 142 may be configured to blind decode each PDCCH candidate within the configured search spaces to detect the first PDCCH 1030 and the second PDCCH 1032. The PDCCH component 142 may associate the first PDCCH 1030 with a first set of SI message resources and associate the second PDCCH 1032 with a second set of SI message resources. The PDCCH component 142 may output the first set of SI message resources to the first message component 144 and output the second set of SI message resources to the second message component 146.

In some implementations, the first PDCCH and the second PDCCH are in a same slot on non-overlapping logical CCEs. In some implementations, the first PDCCH and the second PDCCH are in different slots within the overlapping windows. In some implementations, the first PDCCH 1030 is CRC protected with a first SI-RNTI and the second PDCCH is CRC protected with a different second SI-RNTI. The PDCCH component 142 may check the respective CRC of the first PDCCH 1030 and the second PDCCH 1032 with each of the first SI-RNTI and the second SI-RNTI.

In some implementations, the PDCCH component 142 is configured to obtain the first PDCCH from a first set of CCEs and obtain the second PDCCH from a second set of CCEs. The CCEs of both the first set and the second set are in a same control resource set CORESET 810. The second set of CCEs may be associated with a different search space 830 than the first set of CCEs. In some implementations, the first set of CCEs and the second set of CCEs are associated with a same aggregation level or different aggregation levels.

In some implementations, the PDCCH component 142 is configured to obtain the first PDCCH from a first set of CCEs and obtain the second PDCCH from a second set of CCEs. The CCEs of both the first set and the second set are in a same control resource set CORESET 810. The second set of CCEs may be associated with a different search space 830 than the first set of CCEs. In some implementations, the first set of CCEs and the second set of CCEs are associated with a same aggregation level or different aggregation levels.

In some implementations, the PDCCH component 142 is configured to obtain the first PDCCH 1030 via a first CORESET 910 and obtain the second PDCCH 1032 via a second CORESET 920.

In some implementations, the first PDCCH 1030 includes a first control information (e.g., a DCI) and the second PDCCH includes a second control information. A content of the first control information may include one or both of a SIB identifier and/or a SIB version of the first system information message. A content of the second DCI may include one or both of a SIB identifier and/or a SIB version of the second system information message. The PDCCH component 142 may be configured to use the SIB identifiers and/or SIB versions to associate each PDCCH with a respective SI message.

The first message component 144 is configured to obtain a first system information message via resources indicated by the first PDCCH 1030. For example, the first message component 144 may obtain the first SI message resources from the PDCCH component 142. The first message component 144 may receive the first SI message from the receiver component 1170 via the first SI message resources. For instance, the first message component 144 may receive a PDSCH corresponding to the first SI message resources. The first message component 144 may decode the PDSCH to obtain the system information in the content of the first SI message. The first message component 144 may output the system information to a configuration component 1130.

The second message component 146 is configured to obtain a second system information message via resources indicated by the second PDCCH 1032. For example, the second message component 146 may obtain the second SI message resources from the PDCCH component 142. The second message component 146 may receive the second SI message from the receiver component 1170 via the second SI message resources. For instance, the second message component 146 may receive a PDSCH corresponding to the second SI message resources. The second message component 146 may decode the PDSCH to obtain the system information in the content of the second SI message. The second message component 146 may output the system information to a configuration component 1130.

The configuration component 1130 may be configured to store system information. For instance, the configuration component 1130 may obtain the system information from the first message component 144 and/or the second message component 146. The configuration component 1130 may determine whether any system information is missing, for example, because a SIB was not correctly received. In some implementations, the configuration component 1130 may output a request for on-demand system information for one or more missing SIBs.

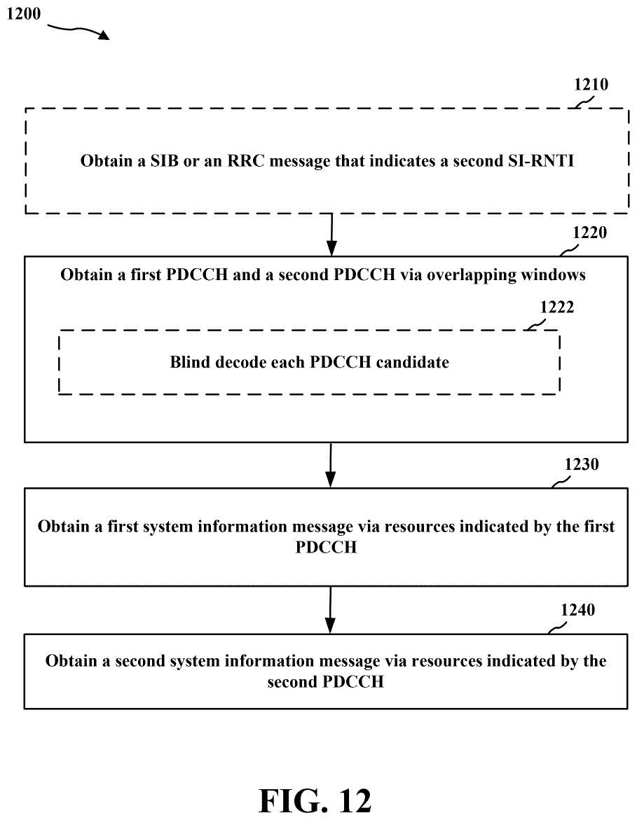

FIG. 12 is a flowchart of an example method 1200 for a wireless node such as a UE to obtain system information via overlapping windows. The method 1200 may be performed by a UE (such as the UE 104, which may include the memory 360 and which may be the entire UE 104 or a component of the UE 104 such as the SIB Rx component 140, TX processor 368, the RX processor 356, or the controller/processor 359). The method 1200 may be performed by the SIB Rx component 140 in communication with the SIB Tx component 120 at a network entity. Optional blocks are shown with dashed lines.

At block 1210, the method 1200 may optionally include obtaining a SIB or an RRC message that indicates a second SI-RNTI. In some implementations, for example, the UE 104, the RX processor 356 or the controller/processor 359 may execute the SIB Rx component 140 or the SI-RNTI component 1120 to obtain the SIB or the RRC message that indicates a second SI-RNTI. Accordingly, the UE 104, the RX processor 359, or the controller/processor 359 executing the SIB Rx component 140 or the SI-RNTI component 1120 may provide means for obtaining a SIB or an RRC message that indicates a second SI-RNTI.

At block 1220, the method 1200 includes obtaining a first PDCCH and a second PDCCH via overlapping windows. In some implementations, for example, the UE 104, the RX processor 356 or the controller/processor 359 may execute the SIB Rx component 140 or the PDCCH component 142 to obtain a first PDCCH 1030 and a second PDCCH 1032 via overlapping windows. For instance, in some implementations, at sub-block 1022, the block 1220 may optionally include blind decoding each PDCCH candidate. For instance, the PDCCH component 142 may blind decode each PDCCH candidate within one or more search spaces or CORESETs. In some implementations, the PDCCH component 142 may check the CRC of each decoded PDCCH candidate with the first SI-RNTI and the second SI-RNTI. Accordingly, the UE 104, the RX processor 356, or the controller/processor 359 executing the SIB Rx component 140 or the PDCCH component 142 may provide means for obtaining a first PDCCH and a second PDCCH via overlapping windows.

At block 1230, the method 1200 includes obtaining a first system information message via resources indicated by the first PDCCH. In some implementations, for example, the UE 104, the RX processor 356 or the controller/processor 359 may execute the SIB Rx component 140 or the first message component 144 to obtain a first system information message 1040 via resources indicated by the first PDCCH 1030. Accordingly, the UE 104, the RX processor 356, or the controller/processor 359 executing the SIB Rx component 140 or the first message component 144 may provide means for obtaining a first system information message via resources indicated by the first PDCCH.

At block 1240, the method 1200 includes obtaining a second system information message via resources indicated by the second PDCCH. In some implementations, for example, the UE 104, the RX processor 356 or the controller/processor 359 may execute the SIB Rx component 140 or the second message component 146 to obtain the second system information message 1042 via resources indicated by the second PDCCH 1032. Accordingly, the UE 104, the RX processor 356, or the controller/processor 359 executing the SIB Rx component 140 or the second message component 146 may provide means for obtaining a second system information message via resources indicated by the second PDCCH.

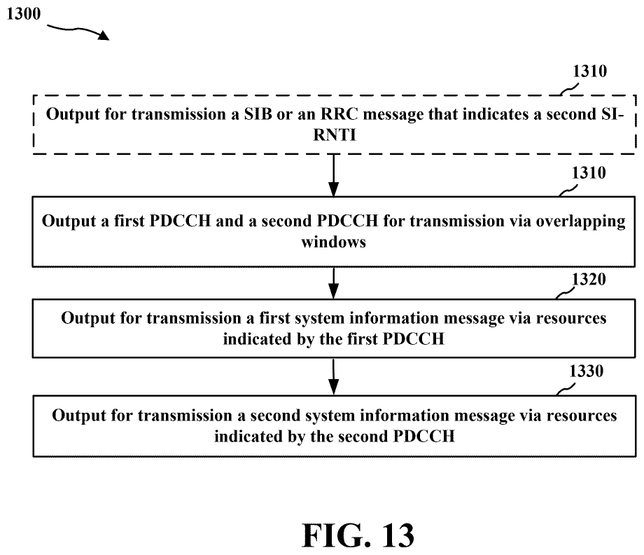

FIG. 13 is a flowchart of an example method 1300 for a wireless node such as a network entity to deliver system information within overlapping windows. The method 1300 may be performed by a network entity 1002 such as a base station (such as the base station 102, which may include the memory 376 and which may be the entire base station 102 or a component of the base station 102 such as a DU 430 including the SIB delivery component 130, TX processor 316, RX processor 370, or the controller/processor 375). The method 1300 may be performed by the SIB Tx component 120 in communication with the SIB Rx component 140 at a UE. Optional blocks are shown with dashed lines.

At block 1310, the method 1300 may optionally include outputting for transmission a SIB or an RRC message that indicates a second SI-RNTI. In some implementations, for example, the network entity 1002, the TX processor 316, or the controller/processor 375 may execute the SIB Tx component 120 or the SI-RNTI component 1050 to output for transmission a SIB or an RRC message that indicates a second SI-RNTI. Accordingly, the network entity 1002, the TX processor 316, or the controller/processor 375 executing the SIB Tx component 120 or the SI-RNTI component 1050 may provide means for outputting for transmission a SIB or an RRC message that indicates a second SI-RNTI.

At block 1320, the method 1300 includes outputting a first PDCCH and a second PDCCH for transmission via overlapping system information windows. In some implementations, for example, the network entity 1002, the TX processor 316, or the controller/processor 375 may execute the SIB Tx component 120 or the PDCCH Tx component 122 to output the first PDCCH 1030 and the second PDCCH 1032 for transmission via overlapping system information windows. Accordingly, the network entity 1002, the Tx processor 316, or the controller/processor 375 executing the SIB Tx component 120 or the PDCCH Tx component 122 may provide means for outputting a first PDCCH and a second PDCCH for transmission via overlapping system information windows.

At block 1330, the method 1300 includes outputting for transmission a first system information message via resources indicated by the first PDCCH. In some implementations, for example, the network entity 1002, the TX processor 316, or the controller/processor 375 may execute the SIB Tx component 120 or the system information message component 124 to output for transmission a first system information message 1040 via resources indicated by the first PDCCH 1030. Accordingly, the network entity 1002, the Tx processor 316, or the controller/processor 375 executing the SIB Tx component 120 or system information message component 124 may provide means for outputting for transmission a first system information message via resources indicated by the first PDCCH.

At block 1340, the method 1300 includes outputting for transmission a second system information message via resources indicated by the second PDCCH. In some implementations, for example, the network entity 1002, the TX processor 316, or the controller/processor 375 may execute the SIB Tx component 120 or the system information message component 124 to output for transmission a second system information message 1042 via resources indicated by the second PDCCH 1032. Accordingly, the network entity 1002, the Tx processor 316, or the controller/processor 375 executing the SIB Tx component 120 or system information message component 124 may provide means for outputting for transmission a second system information message via resources indicated by the second PDCCH.

In some cases, rather than actually transmitting a message, a device may have an interface to output a message for transmission (a means for outputting). For example, a processor may output a message, via a bus interface, to a radio frequency (RF) front end for transmission. Similarly, rather than actually receiving a message, a device may have an interface to obtain a message received from another device (a means for obtaining). For example, a processor may obtain (or receive) a message, via a bus interface, from an RF front end for reception. In some cases, the interface to output a message for transmission and the interface to obtain a message (which may be referred to as first and second interfaces herein) may be the same interface.

Means for obtaining, means for outputting, means for decoding may include any of the various processors and/or memories shown in FIG. 3. Means for receiving and/or means for transmitting may include any of the various processors, memories, and/or transceivers shown in FIG. 3.

The following numbered examples provide an overview of aspects of the present disclosure:

Example 1. A method for wireless communication at a wireless node, comprising: obtaining a first physical downlink control channel (PDCCH) and a second PDCCH via overlapping windows; obtaining a first system information message via resources indicated by the first PDCCH; and obtaining a second system information message via resources indicated by the second PDCCH.

Example 2. The method of example 1, wherein the first PDCCH is cyclic-redundancy check (CRC) protected with a first system information radio network temporary identifier (SI-RNTI) and the second PDCCH is CRC protected with a different second SI-RNTI.

Example 3. The method of example 2, further comprising obtaining a system information block (SIB) or a radio resource control (RRC) message that indicates the second SI-RNTI.

Example 4. The method of example 2, wherein the second SI-RNTI is a predefined value.

Example 5. The method of any of examples 1-4, wherein the first PDCCH and the second PDCCH are obtained in a same slot on non-overlapping logical control channel elements (CCEs).

Example 6. The method of any of examples 1-4, wherein the first PDCCH and the second PDCCH are obtained in different slots within the overlapping windows.

Example 7. The method of any of examples 1-6, wherein obtaining the first PDCCH and the second PDCCH comprises blind decoding each PDCCH candidate.

Example 8. The method of any of examples 1-6, wherein the first PDCCH is obtained from a first set of common control elements (CCEs) and the second PDCCH is obtained from a second set of CCEs, the CCEs of both the first set and the second set being within a same control resource set (CORESET).

Example 9. The method of example 8, wherein the second set of CCEs is associated with a different search space than the first set of CCEs.

Example 10. The method of example 8 or 9, wherein the first set of CCEs and the second set of CCEs are associated with a same aggregation level or different aggregation levels.

Example 11. The method of any of examples 1-6, wherein the first PDCCH is obtained via a first CORESET and the second PDCCH is obtained via a second CORESET.

Example 12. The method of any of examples 1-11, wherein the first PDCCH includes a first control information and the second PDCCH includes a second control information, wherein a content of the first control information includes one or both of a SIB identifier or a SIB version of the first system information message, or a content of the second control information includes one or both of a SIB identifier or a SIB version of the second system information message.

Example 13. A method for wireless communication at a wireless node, comprising: outputting a first physical downlink control channel (PDCCH) and a second PDCCH for transmission via overlapping system information windows; outputting for transmission a first system information message via resources indicated by the first PDCCH; and outputting for transmission a second system information message via resources indicated by the second PDCCH.

Example 14. The method of example 13, wherein the first PDCCH is cyclic-redundancy check (CRC) protected with a first system information radio network temporary identifier (SI-RNTI) and the second PDCCH is CRC protected with a different second SI-RNTI.

Example 15. The method of example 14, further comprising outputting for transmission a system information block (SIB) or a radio resource control (RRC) message that indicates the second SI-RNTI.

Example 16. The method of any of examples 13-15, wherein the first PDCCH and the second PDCCH are output for transmission in a same slot on non-overlapping logical control channel elements (CCEs).

Example 17. The method of any of examples 13-15, wherein the first PDCCH and the second PDCCH are output for transmission in different slots within the overlapping windows.

Example 18. The method of any of examples 13-17, wherein the first PDCCH is output for transmission on a first set of common control elements (CCEs) and the second PDCCH is output for transmission on a second set of CCEs within a same control resource set (CORESET).

Example 19. The method of example 18, wherein the second set of CCEs is a different search space than the first set of CCEs.

Example 20. The method of example 18 or 19, wherein the first set of CCEs and the second set of CCEs have a same or different aggregation level.

Example 21. The method of any of examples 13-17, wherein the first PDCCH is output for transmission on a first CORESET and the second PDCCH is output for transmission on a second CORESET.

Example 22. The method of any of examples 13-21, wherein the first PDCCH includes a first control information and the second PDCCH includes a second control information, wherein a content of the first control information includes one or both of a SIB identifier or a SIB version of the first system information message and/or a content of the second control information includes one or both of a SIB identifier or a SIB version of the second system information message.

Example 23 is an apparatus for wireless communications, comprising means for performing a method in accordance with any one of examples 1-12.

Example 24 is an apparatus for wireless communications, comprising means for performing a method in accordance with any one of examples 13-22.

Example 25 is a non-transitory computer-readable medium comprising instructions that, when executed by a wireless node (e.g., UE), cause the wireless node to perform a method in accordance with any one of examples 1-12.

Example 26 is a non-transitory computer-readable medium comprising instructions that, when executed by a wireless node (e.g., network entity), cause the wireless node to perform a method in accordance with any one of examples 13-22.

Example 27 is an apparatus for wireless communications, comprising: one or more memories, individually or in combination, having instructions; and one or more processors, individually or in combination, configured to execute the instructions and cause the apparatus to perform a method in accordance with any one of examples 1-12.

Example 28 is an apparatus for wireless communications, comprising: one or more memories, individually or in combination, having instructions; and one or more processors, individually or in combination, configured to execute the instructions and cause the apparatus to perform a method in accordance with any one of examples 13-22.

Example 29 is a wireless node (e.g., UE), comprising: one or more transceivers; one or more memories, individually or in combination, having instructions; and one or more processors, individually or in combination, configured to execute the instructions and cause the wireless node to perform a method in accordance with any one of examples 1-12, wherein the one or more transceivers are configured to: receive the first PDCCH, the second PDCCH, the first system information, and the second system information.

Example 34 is a wireless node (e.g., network entity such as a DU), comprising: one or more transceivers; one or more memories, individually or in combination, having instructions; and one or more processors, individually or in combination, configured to execute the instructions and cause the wireless node to perform a method in accordance with any one of examples 13-21, wherein the one or more transceivers are configured to: transmit the first PDCCH, the second PDCCH, the first system information, and the second system information.

As used herein, a phrase referring to “at least one of” a list of items refers to any combination of those items, including single members. As an example, “at least one of: a, b, or c” is intended to cover: a, b, c, a-b, a-c, b-c, and a-b-c. Similarly, as used herein, a phrase referring to “one or more of” a list of items refers to any combination of those items, including single members. As an example, “one or more of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus for wireless communication, comprising:
one or more memories, individually or in combination, having instructions; and
one or more processors, individually or in combination, configured to execute the instructions and cause the apparatus to:
obtain a first physical downlink control channel (PDCCH) and a second PDCCH via overlapping windows;
obtain a first system information message via resources indicated by the first PDCCH; and
obtain a second system information message via resources indicated by the second PDCCH.

2. The apparatus of claim 1, wherein the first PDCCH is cyclic-redundancy check (CRC) protected with a first system information radio network temporary identifier (SI-RNTI) and the second PDCCH is CRC protected with a different second SI-RNTI.

3. The apparatus of claim 2, wherein one or more processors, individually or in combination, are further configured to execute the instructions and cause the apparatus to obtain a system information block (SIB) or a radio resource control (RRC) message that indicates the second SI-RNTI.

4. The apparatus of claim 2, wherein the second SI-RNTI is a predefined value.

5. The apparatus of claim 1, wherein the first PDCCH and the second PDCCH are obtained in a same slot on non-overlapping logical control channel elements (CCEs).

6. The apparatus of claim 1, wherein the first PDCCH and the second PDCCH are obtained in different slots within the overlapping windows.

7. The apparatus of claim 1, wherein to obtain the first PDCCH and the second PDCCH, the one or more processors, individually or in combination, are configured to execute the instructions and cause the apparatus to blind decode each PDCCH candidate 8. The apparatus of claim 1, wherein the first PDCCH is obtained from a first set of common control elements (CCEs) and the second PDCCH is obtained from a second set of CCEs, the CCEs of both the first set and the second set being within a same control resource set (CORESET).

9. The apparatus of claim 8, wherein the second set of CCEs is associated with a different search space than the first set of CCEs.

10. The apparatus of claim 8, wherein the first set of CCEs and the second set of CCEs are associated with a same aggregation level or different aggregation levels.

11. The apparatus of claim 1, wherein the first PDCCH is obtained via a first CORESET and the second PDCCH is obtained via a second CORESET.

12. The apparatus of claim 1, wherein the first PDCCH includes a first control information and the second PDCCH includes a second control information, wherein a content of the first control information includes one or both of a SIB identifier or a SIB version of the first system information message, or a content of the second control information includes one or both of a SIB identifier or a SIB version of the second system information message.

13. The apparatus of claim 1, further comprising one or more transceivers configured to:
receive the first PDCCH, the second PDCCH, the first system information message, and the second system information message, wherein the apparatus is configured as a user equipment (UE).

14. An apparatus for wireless communication, comprising:
one or more memories, individually or in combination, having instructions; and
one or more processors, individually or in combination, configured to execute the instructions and cause the apparatus to:
output a first physical downlink control channel (PDCCH) and a second PDCCH for transmission via overlapping system information windows;
output for transmission a first system information message via resources indicated by the first PDCCH; and
output for transmission a second system information message via resources indicated by the second PDCCH.

15. The apparatus of claim 14, wherein the first PDCCH is cyclic-redundancy check (CRC) protected with a first system information radio network temporary identifier (SI-RNTI) and the second PDCCH is CRC protected with a different second SI-RNTI.

16. The apparatus of claim 15, wherein one or more processors, individually or in combination, are further configured to execute the instructions and cause the apparatus to output for transmission a system information block (SIB) or a radio resource control (RRC) message that indicates the second SI-RNTI.

17. The apparatus of claim 15, wherein the first PDCCH and the second PDCCH are output for transmission in a same slot on non-overlapping logical control channel elements (CCEs).

18. The apparatus of claim 15, wherein the first PDCCH and the second PDCCH are output for transmission in different slots within the overlapping windows.

19. The apparatus of claim 14, wherein the first PDCCH is output for transmission on a first set of common control elements (CCEs) and the second PDCCH is output for transmission on a second set of CCEs within a same control resource set (CORESET).

20. The apparatus of claim 19, wherein the second set of CCEs is a different search space than the first set of CCEs.

21. The apparatus of claim 19, wherein the first set of CCEs and the second set of CCEs have a same or different aggregation level.

22. The apparatus of claim 14, wherein the first PDCCH is output for transmission on a first CORESET and the second PDCCH is output for transmission on a second CORESET.

23. The apparatus of claim 14, wherein the first PDCCH includes a first control information and the second PDCCH includes a second control information, wherein a content of the first control information includes one or both of a SIB identifier or a SIB version of the first system information message, and/or a content of the second control information includes one or both of a SIB identifier or a SIB version of the second system information message.

24. The apparatus of claim 14, further comprising one or more transceivers configured to transmit the first PDCCH, the second PDCCH, the first system information message, and the second system information message, wherein the apparatus is configured as a network entity.

25. A method for wireless communication at a wireless node, comprising:
obtaining a first physical downlink control channel (PDCCH) and a second PDCCH via overlapping windows;
obtaining a first system information message via resources indicated by the first PDCCH; and
obtaining a second system information message via resources indicated by the second PDCCH.
